(19) United States
(12) Patent Application Publication
(10) Pub. No.: US 2008/0226862 A1
(43) Pub. Date: Sep. 18, 2008

(54) Barrier Gasket

(75) Inventor: Charles D. Spurrell, Billerica, MA (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/064,164

(22) PCT Filed: Aug. 19, 2005
(86) PCT No.: PCT/US05/29601

§ 371 Date: Feb. 19, 2008

(51) Int. Cl. B32B 3/02; B29C 44/00

(52) U.S. Cl. 428/66.4; 264/79

(57) ABSTRACT

A barrier gasket (20, 120, 220, 320, 420, 520) uses two different materials to seal between components (22, 24). The first relatively inexpensive material (30, 130, 230, 330, 430, 530) is used for the base material and a second material (40, 140, 240, 340, 440, 540) is used to form the seal that contacts the fluid. The second material (40, 140, 240, 340, 440, 540) is compatible with and chemically resistant to the fluid with which it will come into contact. The second material (40, 140, 240, 340, 440, 540) forms a protective barrier that prevents the fluid from coming in contact with the first material (30, 130, 230, 330, 430, 530).

### FIELD OF THE INVENTION

The present invention relates generally to gaskets and, more particularly to a composite gasket.

### BACKGROUND OF THE INVENTION

Gaskets are used between components to statically seal a fluid within the components. Typical gaskets include a compressible material that forms the static seal when compressed between the components. The gaskets may also include a rigid carrier to hold the shape of the gasket and facilitate handling or alignment of the gasket on the components.

Different types of fluids may require different types of gaskets or different materials of construction to form the seal. That is, part of the gasket will be in direct contact with the fluid and, accordingly, needs to be compatible with and chemically resistant to the fluid. Additionally, environmental regulations may dictate requirements as to the allowable emissions of the fluid through the gasket. For example, when the gasket is used to seal a hydrocarbon fluid, the allowable permeation of the hydrocarbon through the gasket may be regulated. Furthermore, depending upon the environment within which the gasket is used, such as in engines or other harsh environments, the gasket material must also be capable of withstanding large temperature variations and/or variations in the fluid pressure.

To meet these needs, the compressible material used to make the gasket is chosen to be compatible with and chemically resistant to the fluid. Furthermore, the material is chosen to meet the other operating requirements, such as the temperature variation, the fluid pressure, and the required sealing force. Depending on the fluid, the material used to meet these requirements may be expensive. Moreover, as the allowable emission regulations change, the required material used to form the gasket may also change and further increase the cost. Additionally, the chemically compatible material may have a relatively low strain-to-break property (i.e., the amount of strain that the material can handle before failure occurs). As such, the compressive sealing force that can be imparted upon such material may be limited and less than optimal. Thus, it would be advantageous to meet the above requirements at a reduced cost. Furthermore, it would be advantageous if such a gasket could be easily and economically made thereby further reducing the cost of the gasket.

### SUMMARY OF THE INVENTION

A gasket according to the principles of the present invention uses two different materials to seal between components. A first relatively inexpensive material is used for the base material and a second material is used to form the actual seal and contact the fluid. The second material is chosen to be compatible with and chemically resistant to the fluid with which it will come into contact. The second material forms a protective barrier that prevents the fluid from coming in contact with the first (less expensive) material.

In one aspect of the present invention, a composite gasket for providing a sealed relationship between two components is disclosed. The gasket includes an outer perimeter, an inner perimeter which defines an opening and a carrier. A first compressible material is at least partially disposed on the carrier. A second material different than the first material covers at least a portion of the first material. The gasket has a static sealing surface that is operable to engage with and seal against at least one of the components. The static sealing surface is formed by the second material.

In another aspect according to the principles of the present invention, the gasket includes a compressible material at least partially disposed on the carrier and a protective layer disposed on at least a portion of the compressive material. The protective layer is operable to statically seal against a surface and prevent a sealed fluid from contacting the compressible material.

In yet another aspect according to the principles of the present invention, the gasket includes a first compressible material at least partially disposed on the carrier. The first material is capable of withstanding a maximum strain of up to a first value without rupturing. A second material different than the first material covers at least a portion of the first material and forms a sealing surface against one of the members. The second material is capable of withstanding a maximum strain of up to a second value, less than the first value, without rupturing.

In still another aspect of the present invention, a method of making a gasket resistant to a predetermined fluid is disclosed. The method includes: (1) forming a first compressible material into a desired shape; (2) disposing the first material at least partially on a carrier; and (3) forming a static sealing surface with a second material by disposing the second material on at least a portion of the first material. The second material is different than the first material and the second material has a chemical resistance to the predetermined fluid greater than that of the first material. The second material is disposed in an orientation that causes the second material to be in contact with the fluid to be sealed and prevents the fluid from contacting the first material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a gasket according to the principles of the present invention disposed between components to be sealed together;

FIG. 2A is a cross-sectional view of the gasket taken along line 2-2 of FIG. 1 showing a first embodiment of a gasket according to the principles of the present invention;

FIG. 2B is a cross-sectional view of the gasket taken along line 2-2 of FIG. 1 illustrating a second embodiment of the gasket according to the principles of the present invention;

FIG. 2C is a cross-sectional view of the gasket taken along line 2-2 of FIG. 1 illustrating a third embodiment of the gasket according to the principles of the present invention;

FIG. 2D is a cross-sectional view of the gasket taken along line 2-2 of FIG. 1 illustrating a fourth embodiment of the gasket according to the principles of the present invention;

FIG. 2E is a cross-sectional view of the gasket taken along line 2-2 of FIG. 1 illustrating a fifth embodiment of the gasket according to the principles of the present invention;

FIG. 3A is a model of a cross-sectional sealing portion of a gasket according to the principles of the present invention upon which a theoretical finite element analysis is performed; and

FIG. 3B is a theoretical finite element analysis of the strain of the sealing portion of the gasket of FIG. 3A when compressed to the thickness of the carrier.

### DETAILED DESCRIPTION OF THE PREFERRED EMBODIMENTS

The following description of the preferred embodiment(s) is merely exemplary in nature and is in no way intended to limit the invention, its application, or uses.

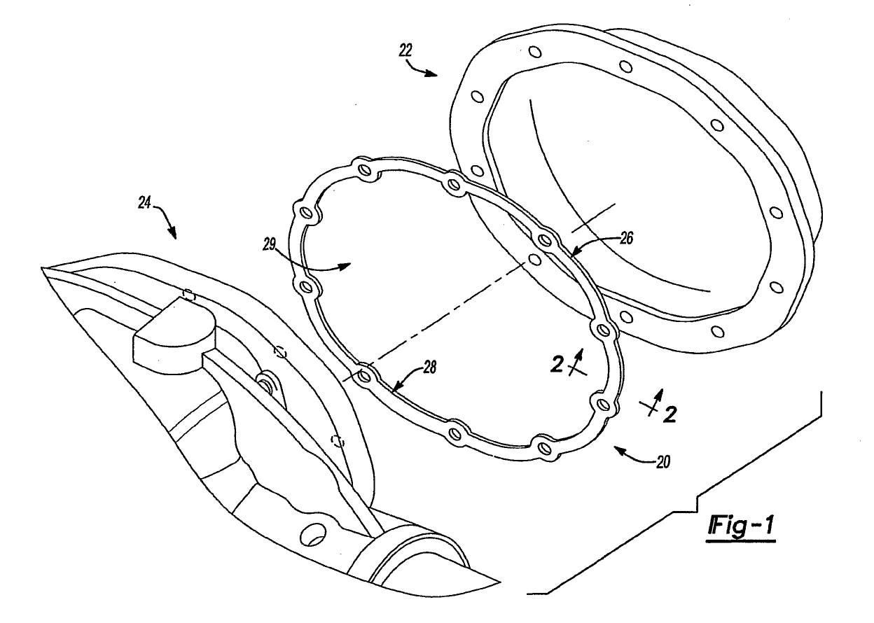

A gasket 20 according to the principles of the present invention for use in forming a static seal between two components or members 22, 24 is shown in FIG. 1. Gasket 20 has an outer perimeter 26 and an inner perimeter 28 that defines a central opening 29. Gasket 20 is a composite gasket that uses a first compressible material and a second material. The second material operates as a barrier or protective layer, forms the static sealing surface, and prevents the fluid being sealed from contacting the first material. The use of a barrier or protective layer allows the first material to be formed by a relatively less expensive material while the second material is suitable for contact with the fluid, as described below. The use of the term “static” means that the gasket and/or sealing surface does not move relative to the component being sealed.

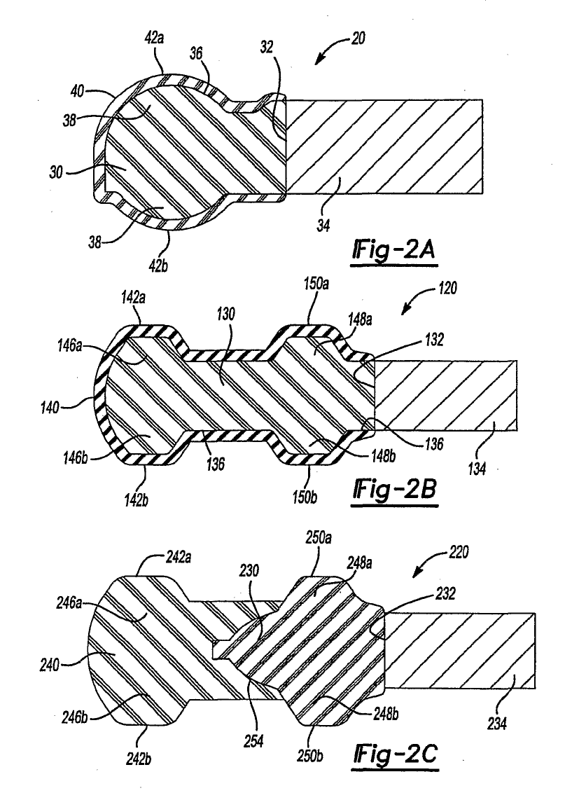

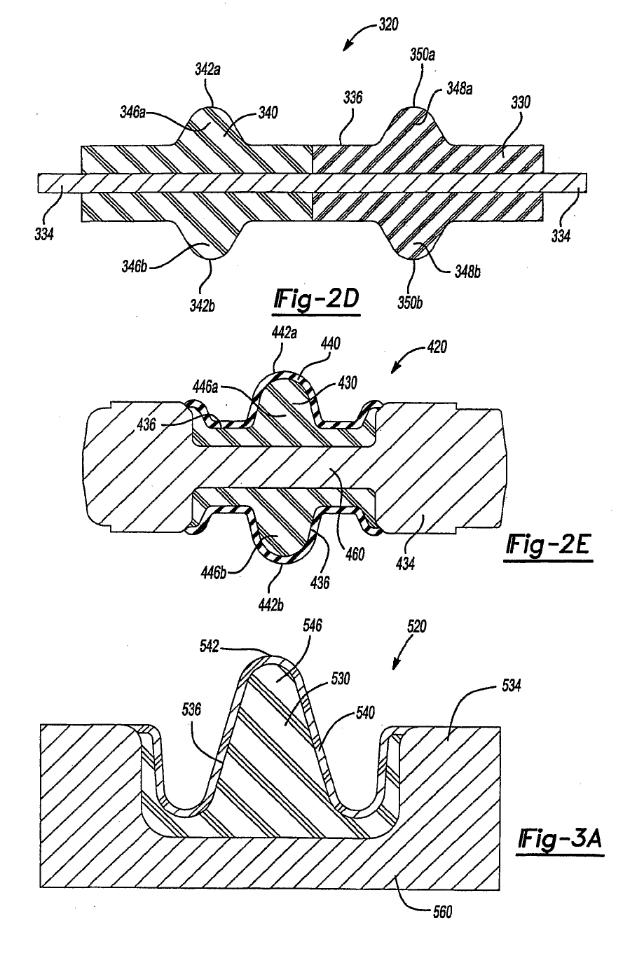

The gasket shown in FIG. 1 is a simplified generic version of the gasket according to the principles of the present invention. The exact configuration of gasket 20 will vary based upon the design and the sealing requirements between components 22, 24. Cross-sectional configurations of various embodiments of gasket 20 according to the principles of the present invention are shown in FIGS. 2A-2E.

In each of the embodiments shown in FIGS. 2A-2E, gasket 20 includes a carrier upon which the first material is disposed. The carrier provides a level of rigidity or stiffness to gasket 20 and facilitates the handling and positioning of gasket 20. The carrier can be made from a variety of materials. For example, the carrier can be made from a metal, such as steel and aluminum, and from a plastic, either singular or composite.

Referring now to FIG. 2A, a cross-section of a first embodiment of gasket 20 is shown. A first material 30 is bound to an edge 32 of a carrier 34. First material 30 has a rounded or circular outer surface 36 that forms a bulbous portion 38. The bulbous portion 38 of first material 30 is compressed by components 22, 24 when fastened together. A second material 40 extends over an entirety of outer surface 36 of first material 30. As such, second material 40 forms a barrier or protective layer over first material 30 and prevents the fluid being sealed from contacting first material 30. Opposite primary sealing surfaces 42a, 42b are formed by second material 40 over bulbous portion 38 of first material 30. Sealing surfaces 42a, 42b contact and seal against components 22, 24 when fastened together. The second material 40 thereby provides the sealing surface for sealing between components 22, 24 and comes in contact with the fluid to be sealed.

Referring now to FIG. 2B, a cross-section of a second embodiment of a gasket 120 according to the principles of the present invention is shown. First material 130 is bound to an edge 132 of carrier 134. First material 130 has a first pair of opposite beads or bulbous projections 146a, 146b that are spaced radially inwardly from a second pair of opposite beads or bulbous projections 148a, 148b. Beads 146, 148 are compressed between components 22, 24 when fastened together. Second material 140 extends over an entirety of the outer surface 136 of first material 130. As such, second material 140 forms a barrier or protective layer over first material 130 and prevents the fluid being sealed from contacting first material 130. Opposite primary sealing surfaces 142a, 142b and opposite secondary sealing surfaces 150a, 150b are formed by second material 140 over the respective first and second pairs of opposite beads 146a, 146b, 148a, 148b of first material 130. Primary and secondary sealing surfaces 142, 150 contact and seal against components 22, 24 when fastened together. Thus, in gasket 120, two sets of sealing surfaces 142, 150 are utilized to seal the fluid within components 22, 24. Furthermore, both sets of sealing surfaces 142, 150 are formed by second material 140 and thereby protect an entirety of first material 130 from coming into contact with the fluid to be sealed.

Referring now to FIG. 2C, a cross-section of a third embodiment of a gasket 220 according to the principles of the present invention is shown. First material 230 is bound to edge 232 of carrier 234. First material 230 has a pair of opposite beads 248a, 248b that form secondary sealing surfaces 250a, 250b. Beads 248a, 248b are compressed by components 22, 24 when fastened together and secondary sealing surfaces 250a, 250b seal against components 22, 24. First material 230 has a radially extending edge portion 254. Edge portion 254 is configured with a stepped projection of varying size. The stepped projection facilitates the attaching of second material 240 to edge portion 254 of first material 230. Second material 240 does not cover an entirety of outer surface 236 of first material 230. Rather, second material 240 covers only a portion of the outer surface 236 including the radially extending edge portion 254.

Second material 240 has a pair of opposite beads 246a, 246b that are compressed between components 22, 24 when fastened together. Beads 246a, 246b form primary sealing surfaces 242a, 242b and seal against components 22, 24. Primary sealing surfaces 242a, 242b come in contact with the fluid to be sealed. As such, second material 240 prevents the fluid being sealed from contacting first material 230. Thus, in gasket 220, the primary sealing surfaces 242a, 242b are formed by second material 240 while the secondary sealing surfaces 250a, 250b are formed by first material 230 and do not contact the fluid to be sealed.

Referring now to FIG. 2D, a cross-section of a fourth embodiment of gasket 320 according to the principles of the present invention is shown. In this embodiment, both first material 330 and second material 340 are disposed on carrier 334. First material 330 is disposed on a radially outer portion of carrier 334 while second material 340 is disposed on a radially inner portion of carrier 334. First material 330 has a pair of opposite beads 348a, 348b that form secondary sealing surfaces 350a, 350b. Beads 348a, 348b are compressed when components 22, 24 are fastened together. Secondary sealing surfaces 250a, 250b form seals against components 22, 24 when fastened together.

Second material 340 has a pair of opposite beads 346a, 346b that form primary sealing surfaces 342a, 342b. Beads 346a, 346b are compressed when components 22, 24 are fastened together. Primary sealing surfaces 342a, 342b seal against components 22, 24 and prevent the fluid being sealed from contacting first material 330. As such, second material 340 comes in direct contact with the fluid being sealed and provides the primary sealing surface while first material 330 does not come into contact with the fluid to be sealed and provides a secondary sealing surface.

Referring now to FIG. 2E, a cross-section of a fifth embodiment of gasket 420 according to the principles of the present invention is shown. First material 430 is disposed on a recessed portion 460 of carrier 434. First material 430 has a pair of opposite beads 446a, 446b that are compressed by components 22, 24 when fastened together. Second material 440 is disposed over an entirety of the outer surface 436 of first material 430. As such, second material 440 forms a barrier or protective layer over first material 430 and prevents the fluid being sealed from contacting first material 430. Opposite sealing surfaces 442a, 442b are formed by second material 440 over beads 446a, 446b of first material 430. Sealing surfaces 442a, 442b seal against components 22, 24 when fastened together and prevent the fluid being sealed from flowing therethrough.

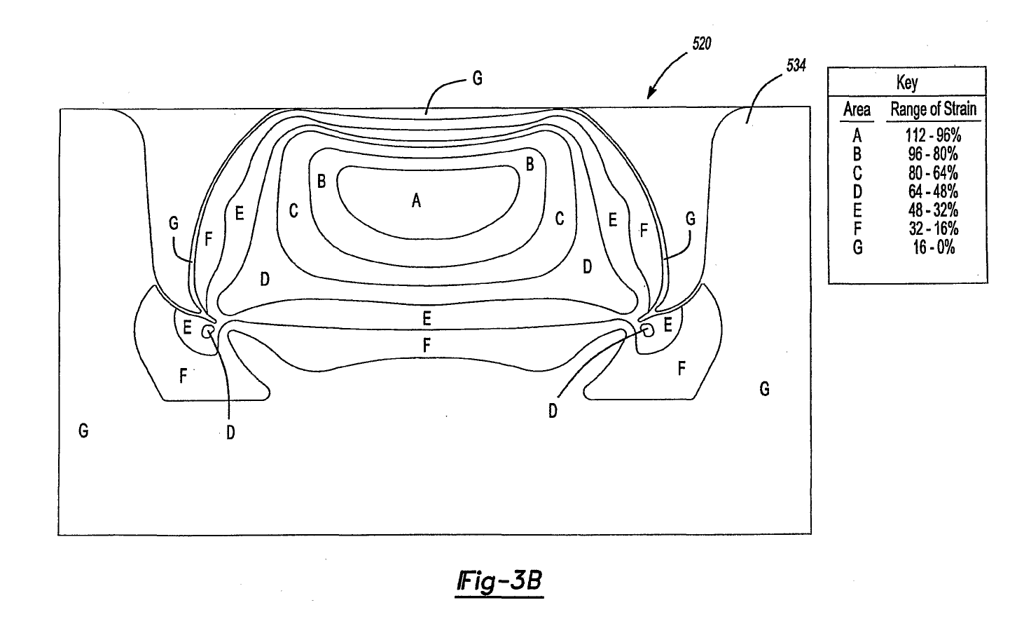

Referring now to FIG. 3A, a model of a sealing portion of a gasket 520 according to the principles of the present invention is shown. The model was used to perform a theoretical finite element analysis of the strain that occurs in the gasket, as discussed below. In the model, first material 530 is disposed on a recessed portion 560 of carrier 534. First material 530 has a bead 546 that will be compressed when components 22, 24 are fastened together. Second material 540 is disposed over an entirety of the outer surface 536 of first material 530. As such, second material 540 forms a barrier or protective layer over first material 530 and prevents the fluid being sealed from contacting first material 530. A sealing surface 542 is formed by second material 540 over bead 546 of first material 530. Sealing surface 542 seals against one of components 22, 24 when fastened together and prevents the fluid being sealed from flowing therethrough.

Referring now to FIG. 3B, a graph of a theoretical finite element analysis of the strain that occurs in first and second materials 530, 540 in model gasket 520 is illustrated. In this analysis, silicone was used as the first material 530 with 0.1 millimeters of FKM used as the second material 540. Carrier 534 was nylon. The analysis is for compression at room temperature with first and second materials 530, 540 being compressed to the thickness of carrier 534. A theoretical maximum principal tensile strain (nominal) analysis was performed. As indicated in the key, the highest strain is predicted to occur in area A, which corresponds to the upper central area of first material 530 while the least strain occurs in areas indicated by G. The predicted strain in first and second materials 530, 540 generally decreases as the materials extend outwardly from area A, as evidenced by the ranges of strain indicated for areas B-G. Based on this theoretical prediction, the strain experienced by first material 530 is the greatest while second material 540 has a significantly lower and, possibly, zero strain. Similar types of results are expected with the gasket configurations shown in FIGS. 2A, 2B and 2E.

Based upon this theoretical prediction, gaskets utilizing a similar arrangement for the first and second materials can employ a second material having a strain-to-break property that is significantly less than the strain-to-break property of the first material. Thus, with this configuration the height or extension of the sealing portion of the gasket that extends above the plane of the carrier can be greater to achieve a greater or optimal sealing force between the components. The strain associated with this optimal or increased thickness will be primarily borne by the first material while the second material that actually forms the sealing interface will experience significantly less strain. Accordingly, the choice for the materials used for the first and second materials can be based upon the chemical resistance and/or the strain-to-break properties for that material. A composite gasket so formed can have a reduced cost while exhibiting the required chemical resistance and applying the required sealing force between the components.

In each of the embodiments shown, the second material 40, 140, 240, 340, 440, 540 comes into direct contact with the fluid to be sealed and prevents the fluid being sealed from contacting first material 30, 130, 230, 330, 430, 530. With this arrangement, the second material is selected to be compatible (e.g. chemical resistance, permeability, and the like) with the fluid to be sealed while the first material does not need to be compatible with the fluid. The first material can therefore be selected based upon other properties, such as resiliency, operating temperature, operating or sealing pressure, strain-to-break property, and the like. The costs of the material suitable for use as the second material (having specific fluid compatibility requirements) can be significantly more expensive than the material suitable for use as the first material. Thus, the present invention allows for the use of a first material to provide the bulk or majority of the material that forms the gasket, while a significantly lower quantity of second material is used to provide a barrier or protective layer and come in contact with the fluid to be sealed. It should be noted that in some of the embodiments shown, the second material is essentially a thin layer or protective coating and represents a significantly less quantity of material than that of the first material. Furthermore, it should also be noted that in the embodiments shown in FIGS. 2C and 2D, the first material forms a significant portion of the gasket that thereby reduces the necessity for forming an entire gasket with the second material. It should be appreciated that the relative dimensions shown for the various components are for illustrative purposes. The actual relative dimensions may vary based upon the configuration and sealing needs between components 22, 24.

A variety of materials can be used for the first and second materials. Some of the factors that influence the selection of the first material include the operating environment, such as the operating temperature and the application pressures that will be experienced, the required resiliency for the gasket and how the resiliency changes as a function of temperature, and the amount of compression or strain the gasket will be subjected to. Some of the factors that influence the choice for the second material include the fluid compatibility, such as the chemical resistance and permeability of the material to the fluid to be sealed, the resilience of the material, and the variations of the resilience with temperature. It should be appreciated that first and second materials can be selected for differing resilient properties such that the first material has a resiliency that is greater than the second material and is operable to maintain appropriate sealing forces at lower temperatures. Another factor to consider in the selection of the first and second materials is the relative cost of the materials. By utilizing a lower cost material for the first material the overall cost of a gasket according to the principles of the present invention can be significantly reduced as opposed to using entirely the second (more expensive) material for both the first and second material portions of the gasket. Furthermore, the reduced cost gasket is chemically compatible with the fluid to be sealed and is operable to meet the appropriate regulations or sealing requirements. Thus, the use of first and second materials to form the gasket provides advantageous results that can reduce the cost of the gasket while meeting the sealing requirements. Accordingly, the material selected as the first material will be different than the material selected as the second material. For example, the first material can include, but is not limited to, silicone, EPDM, natural rubber, ACM, and AEM. The second material can include but is not limited to, FKM, flourosilicone, HNBR, ACM, and AEM.

The gasket according to the principles of the present invention can be made in a variety of methods. For example, the carrier can be stamped or molded. The first material can be compression molded or injection molded onto the carrier. The second material can be compression molded, injection molded, spray coated, or formed by dipping the carrier and first material into a liquefied second material. A binding agent may also be used to facilitate adhesion or bonding between the carrier, the first material and the second material.

The above description of the invention is merely exemplary in nature and, thus, variations that do not depart from the gist of the invention are intended to be within the scope of the invention. For example, the gasket can have a third set or more of sealing surfaces. Additionally, the first and/or second materials can be molded over an entirety of the carrier. Moreover, the shape and orientations of the first and second materials on the carrier can also be varied from that shown to meet the needs of the components to be sealed. Thus, such variations are not to be regarded as a departure from the spirit and scope of the invention.

What is claimed is:

1. A composite gasket for providing a sealed relationship between a first member and a second member, the composite gasket comprising:
an outer perimeter;
an inner perimeter defining an opening;
a carrier;
a first compressible material at least partially disposed on the carrier;
a second material different than the first material, the second material covering at least a portion of the first material; and
a static sealing surface operable to engage with and seal against at least one of the first and second members, the sealing surface formed by the second material.

2. The composite gasket of claim 1, wherein the first material is disposed in a recess in the carrier.

3. The composite gasket of claim 1, wherein the first material is disposed on an edge of the carrier.

4. The composite gasket of claim 1, wherein the gasket is used to seal a predetermined fluid, the first material has a first chemical resistance to the predetermined fluid, the second material has a second chemical resistance to the predetermined fluid, and the second chemical resistance is greater than the first chemical resistance.

5. The composite gasket of claim 1, wherein the first material is silicon.

6. The composite gasket of claim 1, wherein the first material has a first hydrocarbon permeability, the second material has a second hydrocarbon permeability, and the second permeability is less than the first permeability.

7. The composite gasket of claim 1, wherein the first material has a first resiliency, the second material has a second resiliency, and the second resiliency is less than the first resiliency.

8. The composite gasket of claim 1, wherein the first material has a first thickness, the second material has a second thickness, and the second thickness is significantly less than the first thickness.

9. The composite gasket of claim 1, wherein the second material is a coating on the first material.

10. The composite gasket of claim 1, wherein the first material is a resiliently compressible material.

11. The composite gasket of claim 1, wherein the second material prevents a sealed fluid from contacting the first material.

12. The composite gasket of claim 1, wherein the second material covers an entirety of an outer surface of the first material.

13. The composite gasket of claim 1, wherein the first material can withstand a maximum strain of up to a first value without rupturing, the second material can withstand a maximum strain of up to a second value without rupturing, and the second value is less than the first value.

14. A gasket for providing a sealed relationship between a first member and a second member, the gasket comprising:
an outer perimeter;
an inner perimeter defining an opening;
a carrier;
a compressible material at least partially disposed on the carrier; and
a protective layer disposed on at least a portion of the compressible material, the protective layer operable to statically seal against a surface and prevent a sealed fluid from contacting the compressible material.

15. The gasket of claim 14, wherein the protective layer covers an entire outer surface of the compressible material.

16. The gasket of claim 14, wherein the protective layer provides a first sealing interface and the compressible material provides a second sealing interface as a backup to the first sealing interface.

17. The gasket of claim 14, wherein the protective layer is impermeable to hydrocarbons.

18. The gasket of claim 14, wherein the first material is silicon.

19. The gasket of claim 14, wherein a predetermined fluid is being sealed and the protective layer has a chemical resistance to the predetermined fluid greater than a chemical resistance to the predetermined fluid of the compressible material.

20. The gasket of claim 14, wherein the first material can withstand a maximum strain of up to a first value without rupturing, the second material can withstand a maximum strain of up to a second value without rupturing, and the second value is less than the first value.

21. A composite gasket for providing a sealed relationship between a first member and a second member, the composite gasket comprising:
an outer perimeter;
an inner perimeter defining an opening;
a carrier;
a first compressible material at least partially disposed on the carrier, the first material capable of withstanding a maximum strain of up to a first value without rupturing; and
a second material different than the first material, the second material covering at least a portion of the first material and forming a sealing surface against at least one of the first and second members, the second material capable of withstanding a maximum strain of up to a second value without rupturing, the second value being less than the first value.

22. The composite gasket of claim 21, wherein the gasket is used to seal a predetermined fluid, the first material has a first chemical resistance to the predetermined fluid, the second material has a second chemical resistance to the predetermined fluid, and the second chemical resistance is greater than the first chemical resistance.

23. The composite gasket of claim 21, wherein the first material is silicon.

24. The composite gasket of claim 21, wherein the first material has a first thickness, the second material has a second thickness, and the second thickness is significantly less than the first thickness.

25. The composite gasket of claim 21, wherein the second material prevents a sealed fluid from contacting the first material.

26. A method of making a gasket resistant to a predetermined fluid, the method comprising:
(a) forming a first compressible material into a desired shape;
(b) disposing the first material at least partially on a carrier; and
(c) forming a static sealing surface with a second material by disposing the second material on at least a portion of the first material, the second material being different than the first material, the second material having a chemical resistance to the predetermined fluid greater than the first material, and the second material disposed in an orientation that causes the second material to be in contact with the fluid to be sealed and prevents the fluid from contacting the first material.

27. The method of claim 26, wherein (a) includes compression molding the first material.

28. The method of claim 26, wherein (a) includes injection molding the first material.

29. The method of claim 26, wherein (c) includes compression molding the second material onto a portion of the first material.

30. The method of claim 26, wherein (c) includes injection molding the second material onto a portion of the first material.

31. The method of claim 26, wherein (c) includes spraying the second material onto a portion of the first material.

32. The method of claim 26, wherein (c) includes covering an entire outer surface of the first material with the second material.

33. The method of claim 26, wherein (c) includes dipping the first material into a liquefied second material.
